(19) United States
(12) Patent Application Publication
(10) Pub. No.: US 2020/0067767 A1
(43) Pub. Date: Feb. 27, 2020

(54) AUTOMATED PROVISIONING OF NETWORKED ACCESS POINTS BY PORT OR LOCATION

(71) Applicant: HEWLETT PACKARD ENTERPRISE DEVELOPMENT LP, Houston, TX (US)

(72) Inventors: Praveen Krishnakumar Parangattil, Bangalore (IN); Srinivasa Reddy Peddireddy, Bangalore (IN); Venkata Subramaniyan Sundaresan, Bangalore (IN)

(21) Appl. No.: 16/110,919

(22) Filed: Aug. 23, 2018

(51) Int. Cl. H04L 12/24; H04W 16/18; H04W 64/00; H04W 88/08

(52) U.S. Cl. CPC H04L 41/0806; H04W 16/18; H04W 84/12; H04W 88/08; H04W 64/003

(57) ABSTRACT

Access points are automatically provisioned when added, moved, or replaced in a communication network. A profile reflecting a configuration plan for access points in the network is stored in a data store. The profile stores copies of desired configurations and associates them directly or indirectly with switch ports, physical locations, or both. The method uses the network's existing features and functions to discover an access point that lacks a plan-compliant configuration, detect the connected port or physical location, find the associated configuration in the stored profile, and provision the access point with that configuration.

### BACKGROUND

In the field of communication networks, a communications link between two devices may include a type of transceiver known as an access point. Access points may be assigned to different access point groups (AP groups) within a network and provisioned with different configurations. The configurations, may determine protocols, privileges, and other attributes of the access points. Those attributes define how the access point's connected devices interact with the network.

When a new access point is added to an existing network, it must be provisioned with the desired configuration before it can begin communicating. Because access point hardware may be versatile enough to support any of a number of potential configurations, and because a network may include more than one AP group, the provisioning of the new access point may need to be directed by a human operator. For example, the operator may need to manually enter a unique identifier for the new access point (e.g., its media access control (MAC) address or serial number) and define or select a desired configuration for the new access point using a network management interface.

Excess overhead costs may be incurred when human intervention is involved in adding, moving, or replacing access points in a network. These excess costs may include both operator labor costs and the cost of work delay from the time. These costs could potentially be saved if the process of provisioning access points could be fully automated.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, the order of processing may be altered for some functions, both internally and with respect to each other, That is, some functions may not require serial processing and therefore may be performed in an order different than shown or possibly in parallel with each other. For a detailed description of various examples, reference will now be made to the accompanying drawings, in which:

FIG. 1 is a block diagram of a communication network with automated provisioning of access points according to one or more disclosed examples.

FIG. 2 is a functional block diagram of a system automatically provisioning access points based on their locations according to one or more disclosed examples,

FIG. 3 is a functional block diagram of a system automatically provisioning access points based on their connected ports according to one or more disclosed examples.

FIG. 4A is a diagram of a configuration plan for provisioning access points by physical location according to one or more disclosed examples.

FIG. 4B is a schematic table representing a stored location-based configuration profile for the configuration plan of in FIG. 4A according to one or more disclosed examples.

FIG. 5A is a front view of a switch with individually identifiable connected ports according to one or more disclosed examples.

FIG. 5B is an example of a stored port-based profile including schematic table of configurations assigned to the ports shown in FIG. 5A according to one or more disclosed examples.

FIG. 6 is an example of a network including a hardware processor with access to a non-transitory machine-readable storage medium containing instructions and data for automated provisioning of access points according to one or more disclosed example implementations.

### DETAILED DESCRIPTION

The description of the different advantageous embodiments has been presented for purposes of illustration and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

Before the present disclosure is described in detail, it is to be understood that, unless otherwise indicated, this disclosure is not limited to specific procedures or articles, whether described or not. It is further to be understood that the terminology used herein is for the purpose of describing particular embodiments only and is not intended to limit the scope of the present disclosure.

A communication network may include one or more access points through which devices, or groups of devices, interface with the rest of the network. An access point may be described as a transceiver coupling one or more downstream devices (e.g., routers) to an upstream network (e.g., physical or virtual servers including processors, data stores, and other components). An access point's connections may be wireless; alternatively, they may be wired, as through a switch port. Each access point is provisioned with a configuration that may, for example, assign it to an AP group or determine its privileges (e.g., whit list memberships) on, the network. Attributes of the access point's configuration affect how downstream devices are permitted to make use of the network.

Historically, manual intervention has been part of the process of adding, replacing, or relocating access points. A system administrator (sysadmin) or other human operator manually cross-references each access point's physical location with a unique identifier distinguishing the particular access point from other access points in the network. In some instances, the access point's Media Access Control (MAC) address, its serial number, or an administrator-assigned name may be used as the unique identifier. Once the cross-referencing has been done, the operator addresses each access point by its unique identifier and manually provisions it with a configuration according to a configuration plan.

The configuration plan describes (1) the different access point configurations to be used at a given site and (2) which access points will be provisioned with each of the different configurations. Two possible ways to assign configurations to access points are (1) by location (“all access points in Building 1 will be provisioned with Configuration A”) and (2) by connected switch port (“all access points connected to ports 5, 6, and 7 will be provisioned with Configuration B”). The configuration plan may be expressed as a table, a list, a group of written paragraphs, a floor plan or other map, or any other suitable form that can be understood by the intended reader. Under the established method, the unique identifiers may be manually mapped at each location port before provisioning can proceed.

If the access point is moved to another physical location, the operator must track it and, if needed, manually change its configuration. Any access point deployments or redeployments thus result in the delay and information technology (IT) overhead cost associated with the operator's labor, Deployments could be faster and more cost-effective if access points could be provisioned without manual intervention.

The present disclosure includes examples of zero touch provisioning, the configuration of access points without manual intervention. The system is provided with built-in capabilities to automatically discover an access point in need of provisioning (such as a new or relocated access point), detect its connection port or physical location, look up a configuration corresponding to the detected port or physical location, and provision the access point with that configuration. The configuration plan may be stored on the system in the form of a configuration profile. Examples of stored profiles include look-up tables, relational databases, mathematical functions, and encoded floor plans. However, the stored profile, may be in any form that, when given an access point's location or connected port, returns the associated configuration that the system can use to provision the access point.

The approach works similarly for wired, wireless, or mixed networks. Wired systems may persist at legacy sites, in scenarios with high sensitivity to EMI or security, or where wireless reception is unreliable because of the terrain or weather. Furthermore, as long as the access points are discoverable on power-up and can be provisioned with the desired configuration, they need not all be the same brand or model; anything readily available may potentially be deployed, At the same time, this approach is just as convenient for leveraging economy of scale by using the same type of configurable universal access point for every type of connection.

Many existing networks already have suitable processors and data stores, switches for wired connections or beacons for client navigation or other wireless location-tracking purposes, and a network management interface or some other way for an operator to load a profile into the data store. Therefore, some implementations require no new hardware on the network, only some additional software that works on the existing hardware.

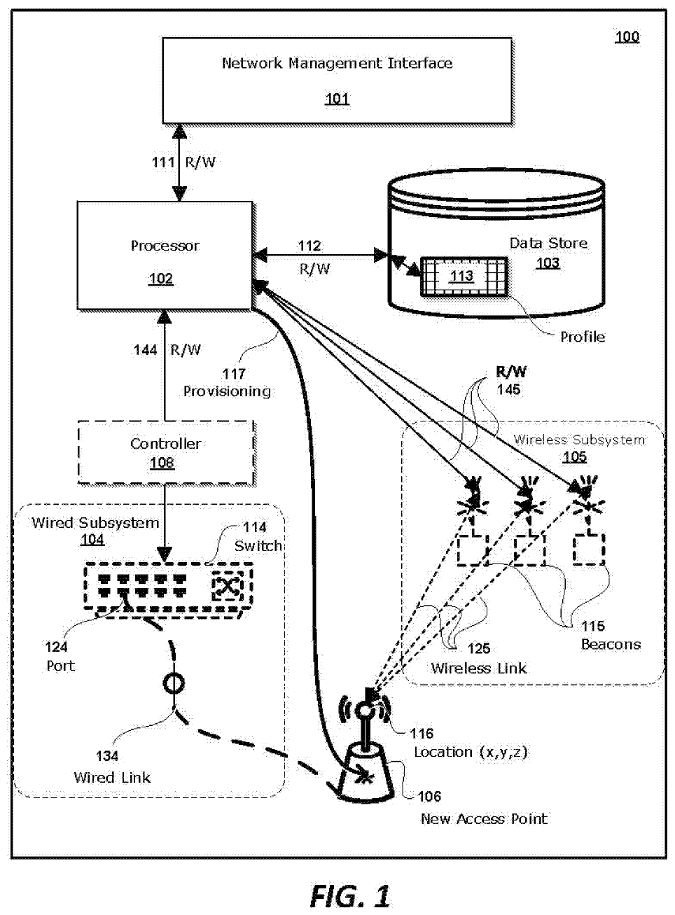

FIG. 1 is a block diagram of a communication network with automated provisioning of access points according to one or more disclosed examples. Some of the illustrated components of network 100 may be physical and others virtual; some may be on-site, and others may be cloud-based. Network 100 may optionally include a wired subsystem 104, a wireless subsystem 105, or both.

New access point 106 has been placed in physical location 116 and powered up. It may be unconfigured, or it may have a configuration that does not comport with the current configuration plan. New access point 106 and its configuration status are discoverable at processor 102, where the discovery triggers automated provisioning 117. Processor 102 or network management interface 101 may discover new access point 106 using Domain Name System (DNS), Dynamic Host Configuration Protocol (DHCP), or any other suitable protocol. In some examples, the automated provisioning 117 and its triggering conditions may be set up or edited through network management interface 101 over read/rite link 111 to processor 102.

If the new access point 106 is connected to a port 124 of a switch 114, for example by a wired link 134, and the configuration plan assigns configurations according to connected switch ports, processor 102 detects the connection of new access point 106 to port 124 of switch 114. In some examples, processor 102 may access a MAC address table in a bridge associated with switch 114. Optionally, communication between switch 114 and processor 102 on read/write link 144 may make use of Link Layer Discovery Protocol (LLDP), a different Layer Two protocol, or any other protocol suitable for use on network 100.

Alternatively, if the new access point 106 is wirelessly coupled to network 100 without an intervening multi-port switch, or if the configuration plan assigns access point configurations according, to physical location, network 100 may detect physical location 116 of new access point 106. In some examples, physical location 116 may be detected over wireless link(s) 125 using one or more beacons 115 within range of new access point 106, Beacons 115 communicate with processor 102 over read/write links 145, which allows the processor to control the beacons and receive data from them. Additionally or alternatively, one or more controllers 108 may ascertain, physical location 116, optionally making it available to the network management interface 101.

Where locations do not need to be detected with high precision, as in a client navigation network for an outdoor venue with widely-spaced features such as historic monuments, beacons 115 may be separated so widely that their practical ranges have lithe or no overlap, and new access point 106 may establish a wireless communication link 125 with only one beacon 115. This single beacon establishes physical location 116 within an error radius roughly the same as the diameter of beacon 115's range. Where the location detection needs to be more precise, as in a client navigation network for an indoor venue with closely-spaced features such as cubicles or open-office desks, two or more beacons 115 may be used to determine physical location 116 more precisely. For instance, three or more beacons 115 may locate new access point 106 by triangulation. However, any suitable, method for the desired precision and the number of in-range beacons may be used.

Once the variable relevant to the configuration plan—i.e., connected port 124 and/or physical location 116—is detected, processor 102 accesses configuration profile 113 on data store 103 over read-write link 112 and queries configuration profile 113 with the detected port 124 or physical location 116. Configuration profile 113 may contain either an exact match to the detected variable or a range that includes the detected variable, Configuration profile 113 may store bridge MAC addresses or other descriptors of ports, GPS coordinates or other descriptors of physical locations, or both. Each stored descriptor in the profile is associated with a unique configuration, based on the configuration plan for network 100. In some examples, the configurations may include assigning new access point 106 to be managed by a particular controller (e.g., controller 108). Processor 102 loads the configuration associated with the matching value for port 124 or physical location 116 and provisions new access point 106 with the configuration.

New access point 106 is now ready to operate as part of network 100, with no manual intervention required at the time of deployment. The configuration profile 113 was previously composed with reference to the configuration plan and loaded once onto data store 103, where it may be used many times and will only need editing if the configuration plan changes.

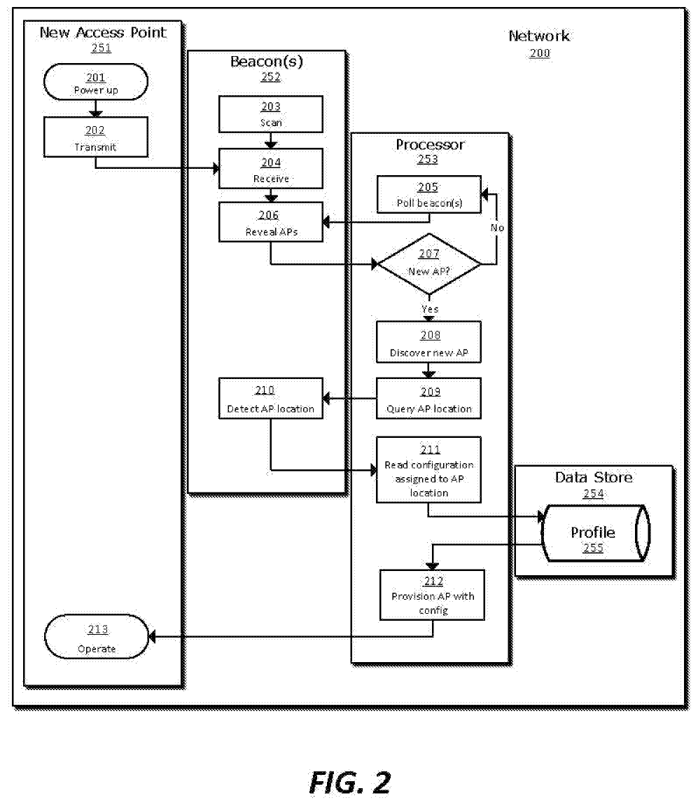

FIG. 2 is a functional block diagram of a system automatically provisioning access points based on their locations according to one or more disclosed examples. Power up 201 of new access point 251 causes a transmission 202 of a wireless packet that renders new access point 251 discoverable in a wireless local area network WLAN). In some implementations, the beacon(s) 252 deployed in the WLAN coverage area may execute a continuous or periodic scan 203 for access points (APs) operating within their Bluetooth (or BLE) wireless signal detection range. Upon reception 204 of the scan results, the beacon(s) reveal the results 206 of the scan, including any discovered APs. Upon reception 204 of the scan results, beacon(s) 252 reveal the results 206. The processor, which may perform a continuous or periodic poll 205 of beacon(s) 252, compare consecutive reveals 206 and run a query 207 as to whether a new access point has been revealed. If not, it returns to polling 205. If so, it runs a wireless local area network (WLAN) discovery process 208 using information specific to the new access point (e.g., DNS or DHCP).

Upon discovery 208 of an address, server connection, or another identifier for new access point 251 in the WLAN, processor 253 issues a location query 209 for new access point 251. The query includes the discovered identifier and enables detection 210 of new access point 251's location by beacon(s) 252. On receiving the location of new access point 251, processor 253 can execute a reading 211 of the configuration associated with that location from profile 255 stored in data store 254, followed by a provisioning 212 of new access point 251 with the configuration. At that time, operation 213 of new access point 251 as part of network 200 may begin. Operation 213 may include any WLAN access service that the new access point can provide for its client devices.

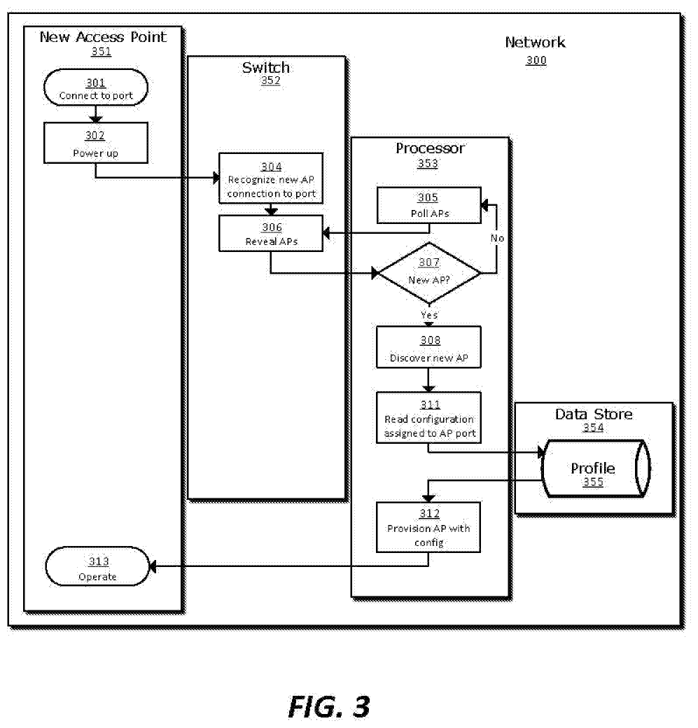

FIG. 3 is a functional block diagram of a system automatically provisioning access points based on their connected ports according to one or more disclosed examples. Powering up 302a new access point with a connection 301 to a switch via a port renders the new access point discoverable upon its recognition 304 by the switch. The processor, which may perform a continuous or periodic poll 305 of the switches, compares consecutive port connection status readings 306 and runs a query 307 as to whether a new access point has been connected. If not, it returns to polling 305. If so, it runs a discovery process 308 for the new access point (e.g., DNS or DHCP).

Upon discovery 308 of new access point 351, the connected port is already known to processor 353 (optionally by reading a MAC address table on the switch bridge of switch 352 or exchanging information with its LLDP neighbors), Processor 353 can then perform a reading 311 of the configuration associated with that port from the profile 355 stored in the data store 354, followed by a provisioning 312 of new access point 351 with the configuration. At that time, operation 313 of new access point 351 as part of the network 300 may begin.

Because the processes illustrated in FIGS. 2 and 3 are fully automated and require no human intervention, the speed for provisioning a new access point is limited only by the speed of the electronic devices involved. Thus an access point that would take minutes to provision by a manual method may be provisioned automatically in less than 1 second. Some implementations may enable provisioning of multiple access points in parallel, or may provision them serially at a high speed. For example, some implementations may provision 20 new access points in less than 1 second.

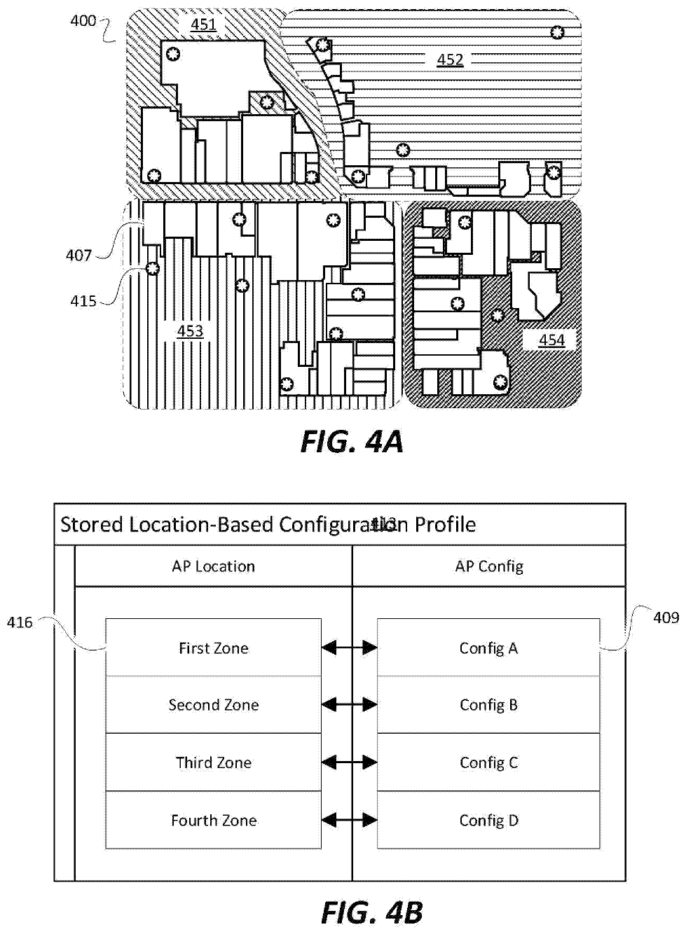

FIG. 4A is a diagram of a configuration plan for provisioning access points by physical location according to one or more disclosed examples. Beacons 415 are placed both inside and outside buildings 407 on site 400. As shown, the distance intervals between beacons 415 are irregular. An irregular spacing may accommodate existing constraints of the site at the time they were installed. In other implementations, beacons 415 may be placed in a grid or other array at known locations. The locations of beacons 415 may be recorded in a data store for future access.

An access point configuration plan divides site 400 into a first zone 451, a second zone 452, a third zone 453, and a fourth zone 454. The configuration plan calls for access points operating on site 400 to be provisioned with different configurations depending on the zone in which they are physically located. For example, workers in, each of the zones may be given access to network resources belonging to a different set of whitelists, or have a different priority for the use of available bandwidth. Thus, the APs located in each zone may be, configured with access privileges to a unique set of network resources and/or with a unique priority for bandwidth allocations.

FIG. 4B is a schematic table representing a stored location-based configuration profile for the configuration plan of in FIG. 4A according to one or more disclosed examples. In stored location-based configuration profile 413, each zone 416 mapped in FIG. 4A is defined (e.g., by a range of GPS coordinates or other convenient location designations) and associated with a configuration 409. For example, the first zone is associated with Configuration A, the second zone with Configuration B, the third zone with Configuration C, and the fourth zone with Configuration D.

In some implementations, the associations may be direct, as in the one-to-one look-up table illustrated for simplicity in FIG. 4B. In others, it may be advantageous to make the associations indirect to save storage space and simplify editing.

Note that although the association between the zones and configurations illustrated in FIG. 4B is a one-to-one relationship, multiple zones can be associated with the same configuration in some examples. In other examples, the same zone can be associated with multiple configurations whereas each configuration may uniquely correspond to a sub-zone. Also, when the same zone is associated with multiple configurations, the system may determine which of the multiple configurations to be applied to a particular AP located within the same zone based on other properties of the particular AP.

For example, suppose an enterprise built ten identical branch sites in different cities and gave them access to a common network. Because the branches are identical, each one has a first zone (“Zone 1”), a second zone (“Zone 2”), a third zone (“Zone 3”), and a fourth zone (“Zone 4”), in which the access points are to be provisioned with Configurations A through D, respectively. Optionally, the stored profile could be a relational database with a many-to-one relationship between physical zones and configurations. With this approach, Zones 1.1 through 10.1 (the “Zone 1”s at each of the ten different branches) may all be associated with a single copy of Configuration A in the profile. If the configuration plan needs to be updated, only one copy of Configuration A needs to be changed. Changing a single copy of the configuration could save time and reduce opportunities for error.

As another example, suppose an enterprise had ten sites in different cities, but the sites were not identical. They may have moved into existing buildings with different floor plans, or they may be different types of sites such, as a corporate office, a warehouse, several customer-facing locations, and a training facility. Some sites may have the four zones shown in FIG. 4A associated with the configurations in FIG. 4B, but others may have different numbers of zones or different configurations planned for the zones. Here, it may be desirable for the stored configuration profile 413 to assign locations to AP groups and associate the AP groups with configurations. For example, the configuration plan may call for Zone 1 at each of Sites 1 through 4, Zone 5 at Site 7, and Zones 3 and 9 at Site 8 to be provisioned with Configuration A. The profile could associate Zones 1.1, 2.1, 3.1, 4.1, 7.5, 8.3, and 8.9 to an AP group and associate the AP group with Configuration A.

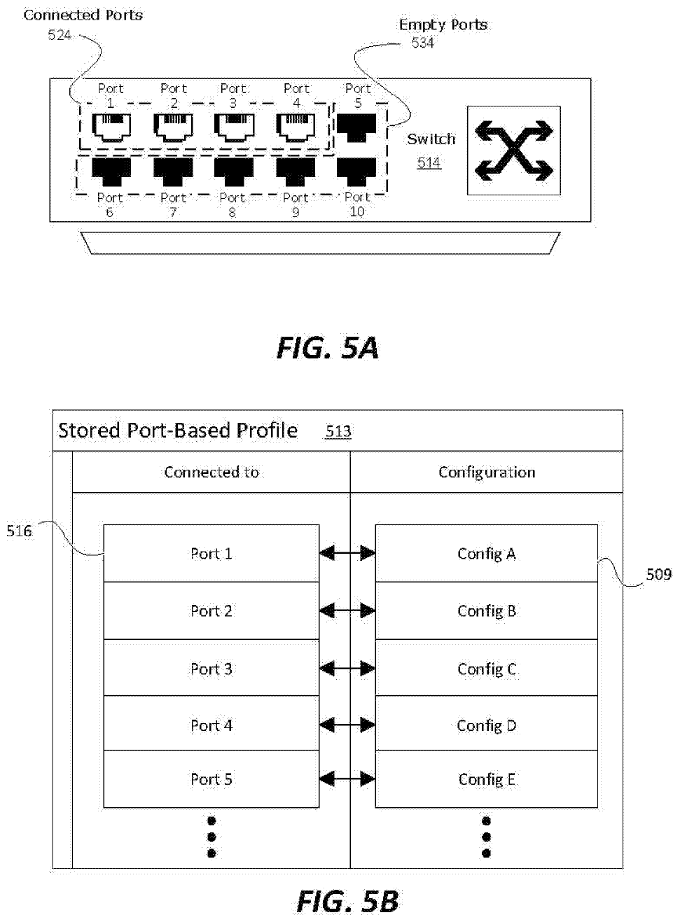

FIG. 5A is a front view of a switch with individually identifiable connected ports according to one or more disclosed examples. Access points connected to each port of switch 514 may optionally be provisioned with different configurations. In the illustrated example, Ports 1-4 in group 524 are connected to access points. Ports 5-10 in group 534 are empty.

FIG. 5B is an example of a stored port-based profile including, schematic table of configurations assigned to the ports shown in FIG. 5A according to one or more disclosed examples. Each port 516 is associated with a configuration 509 that will be provisioned to the connected access point on that port. If the configuration plan is known for empty ports to be connected to access points in the future, the empty ports such as Port 5 may also be associated in the stored port-based profile 513 with configurations such as Configuration E.

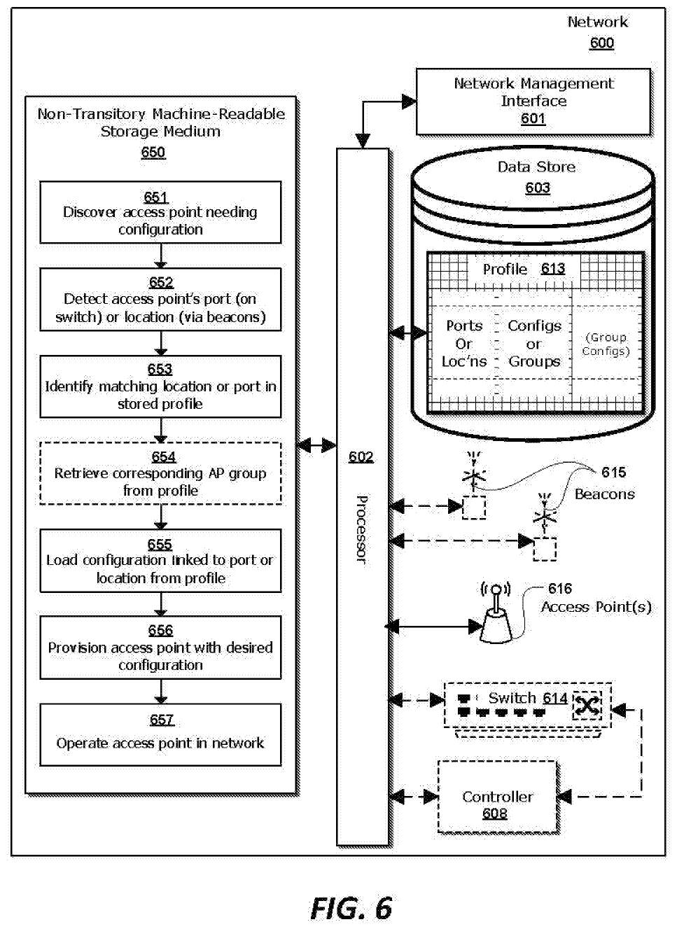

FIG. 6 is an example of a network including a hardware processor with access to a non-transitory machine-readable storage medium containing, instructions and data for automated provisioning of access points according to one or more disclosed example implementations. In network 600, processor 602 is coupled to non-transitory machine-readable storage medium 650, which contains instructions 651-657 for provisioning access point 616 with a configuration based on its connected port on switch 614 or its physical location as determined by beacon(s) 615 or controller 608. Processor 602 is also coupled to network management interface 601, data store 603 containing stored profile 613, beacons 615 or switch 614 or both, optional controller 608, access point 616, and any other hardware instrumental in automated provisioning of access point 616.

The instructions begin with discovery 651 of access point 616, detection 652 of access point 616's location via beacons 615 or connected port on switch 614, and identification 653 of a matching port or location in stored profile 613. If stored profile 613 associates ports or locations indirectly with configurations, such as associating ports or locations with AP groups and further associate AP groups with configurations, optional instruction 654 of retrieving a corresponding AP group from stored profile 613 may be executed. Then the instructions continue with loading 655 from stored profile 613 of the configuration linked to the connected port on switch 614 or the location determined via beacons 615, provisioning 656 of access point 616 with the loaded configuration, and commencement of operation 657 of access point 616 in network 600.

Not all features of an actual implementation are described in every example of this specification. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Certain terms have been used throughout the description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to.” Also, the term “couple” or “couples” is intended to mean either an indirect or direct wired or wireless connection. Thus, if a first device couples to a second device, that connection may be through a direct connection or an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure, Numerous variations and modifications will become apparent to those skilled in the art once the above disclosure is fully appreciated. It is intended that the following claims be interpreted to embrace all such variations and modifications.

What is claimed is:

1. A communications network, comprising:
a data store containing at least a configuration, profile that associates an access point configuration with stored physical location information;
an access point to be provisioned in the communications network; and
a processor configured to:
discover the access point,
receive information about the access point's physical location,
access the data store to load the access point configuration associated with the access point's physical location, and
provision the access point with the loaded access point configuration automatically without intervention from an administrator of the communications network.

2. The communications network of claim 1, further comprising a component configured to detect and transmit the information about the access point's physical location.

3. The communications network of claim 2, wherein the component comprises a first beacon.

4. The communications network of claim 3, wherein the first beacon detects whether the access point's physical location is within its detection range.

5. The communications network of claim 3, further comprising a second beacon and a third beacon;
wherein the access point is detectable by the first beacon, the second beacon, and the third beacon; and
wherein the first beacon, the second beacon, and the third beacon detect the access point's physical location by triangulation.

6. The communications network of claim 1, further comprising a network management interface configured to transmit commands and receive information from the beacon, the data store, or the access point through the processor.

7. The communications network of claim 7, further comprising a controller managed by the network management interface and controlling the access point.

8. A communications network, comprising:
a data store containing at least a configuration profile that associates an access point configuration with stored connected port information;
an access point to be provisioned in the communications network; and
a processor configured to:
discover the access point,
receive information about a switch port connected to the access point,
access the data store to load the access point configuration associated with the switch port, and
provision the access point with the loaded access point configuration automatically without intervention from an administrator of the communications network.

9. The communications network of claim 9, further comprising a component configured to detect and transmit the information about the switch port connected to the access point.

10. The communications network of claim 9, wherein the component comprises a switch.

11. The communications network of claim 9, further comprising a network management interface configured to transmit commands and receive information from the switch, the data store, or the access point through the processor.

12. The communications network of claim 13, further comprising a controller managed by the network management interface and controlling the switch.

13. A non-transitory machine-readable information-storage medium containing instructions and data that, when executed, cause a machine to perform actions comprising:
discovering an access point in need of configuration;
detecting a connected port or a physical location of the access point;
identifying a matching port or a matching location in a stored profile;
loading a configuration associated with the matching port or the matching location in the stored profile; and
provisioning the access point with the configuration.

14. The non-transitory machine-readable information-storage medium of claim 15, wherein the discovering, detecting, reading, and provisioning of the first access point is completed in less than 1 second.

15. The non-transitory machine-readable information-storage medium of claim 15, wherein the detecting of the physical location comprises reading information from a stored floor plan.

16. The non-transitory machine-readable information-storage medium of claim 15, wherein the detecting of the physical location comprises receiving information from the first access point about a beacon or a second access point.

17. The non-transitory machine-readable information-storage medium of claim 15, wherein the detecting of the connected port comprises reading information from a switch bridge.

18. The non-transitory machine-readable information-storage medium of claim 15, wherein the stored profile associates the matching port or the matching location with the configuration indirectly by associating the matching port or the matching location with an access point group and associating the access point group with a configuration.

19. The non-transitory machine-readable information-storage medium of claim 15, wherein at least one of the discovering, detecting, reading, and provisioning is executed through a network management interface.

20. The non-transitory machine-readable information-storage medium of claim 15, wherein the detecting of the physical location comprises receiving information from a controller.
